(19) United States
(12) Patent Application Publication
(10) Pub. No.: US 2026/0260790 A1
(43) Pub. Date: Sep. 3, 2026

(54) METHOD FOR PREPARING AN ELONGATE CONDUCTOR ELEMENT FOR A WELDING PROCESS, AND MACHINE TOOL FOR CARRYING OUT THE METHOD

(71) Applicant: TRUMPF Laser- und Systemtechnik SE, Ditzingen (DE)

(72) Inventors: Oliver Bocksrocker, Sachsenheim (DE); Christoph Neugebauer, Kirchheim unter Teck (DE)

(21) Appl. No.: 19/654,502

(22) Filed: Apr. 22, 2026

Related U.S. Application Data
(63) Continuation of application No. PCT/EP2024/079945, filed on Oct. 23, 2024.

(30) Foreign Application Priority Data
Oct. 24, 2023 (DE) 10 2023 129 213.7

(51) Int. Cl. H01B 13/00; B23K 26/0622; B23K 26/14; B23K 26/362; B23K 26/402; B23K 35/02; B23K 35/28; B23K 35/40; B23K 101/34; B23K 103/10

(52) U.S. Cl. CPC H01B 13/0036; B23K 26/0622; B23K 26/14; B23K 26/362; B23K 26/402; B23K 35/0261; B23K 35/286; B23K 35/404; H01B 13/003; B23K 2101/34; B23K 2103/10

(57) ABSTRACT

A method for preparing an elongate conductor element for a welding process, wherein the elongate conductor element has an electrically conductive core and a coating, and the core contains aluminum, the method including removing the coating within a portion of the elongate conductor element and heating the electrically conductive core by irradiating the portion of the elongate conductor element with a laser beam to form an oxide layer within the portion of the elongate conductor element.

### CROSS REFERENCE TO RELATED APPLICATIONS

This application is a continuation of International Application No. PCT/EP2024/079945 (WO 2025/087964 A1), filed on October 23, 2024, and claims benefit to German Patent Application No. DE 10 2023 129 213.7, filed on October 24, 2023. The aforementioned applications are hereby incorporated by reference herein.

### FIELD

The invention relates to a device and a method for preparing an elongate conductor element and a machine tool for carrying out the method.

### BACKGROUND

DE 10 2020 212 087 A1 describes a method for removing an electrically non-conductive plastic coating from an electrically conductive metal core of a conductor. The plastic coating is removed by repeatedly irradiating the plastic coating with laser radiation.

### SUMMARY

In an embodiment, the present disclosure provides a method for preparing an elongate conductor element for a welding process, wherein the elongate conductor element has an electrically conductive core and a coating, and the core contains aluminum, the method comprising removing the coating within a portion of the elongate conductor element and heating the electrically conductive core by irradiating the portion of the elongate conductor element with a laser beam to form an oxide layer within the portion of the elongate conductor element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an elongate conductor element with a coating during the removal of the coating with a laser beam;

FIG. 2 shows a schematic representation of an overlap of a region of the elongate conductor element of FIG. 1 irradiated with the laser beam;

FIG. 3 shows a schematic representation of possible cross-sections of the laser beam from FIG. 1;

FIG. 4 shows a schematic representation of an elongate conductor element with a coating during the removal of the coating with a laser beam according to an exemplary embodiment;

FIG. 5 shows a schematic representation of a cross-section of a portion of the elongate conductor element from FIG. 1 after removal of the coating;

FIG. 6 shows a schematic representation of the elongate conductor element of FIG. 1 when heated in order to form an oxide layer; and

FIG. 7 shows a schematic representation of the cross-section of FIG. 5 after the formation of an oxide layer.

### DETAILED DESCRIPTION

In an embodiment, the present disclosure provides a method for preparing an elongate conductor element for a welding process which has improved properties, in particular which better prepares the elongate conductor element for the welding process. Furthermore, an embodiment of the present disclosure provides a machine tool designed to carry out such a method.

A method according to an embodiment of the present disclosure is designed for preparing an elongate conductor element for a welding process. The elongate conductor element has an electrically conductive core and a coating. The core contains aluminum. The method includes the steps: removing the coating within a portion of the elongate conductor element, and heating the electrically conductive core by irradiating the portion with a laser beam in order to form an oxide layer in the portion.

The formation of the oxide layer advantageously ensures that, in a subsequent welding process in which the portion is melted at least in parts, the molten material that forms is better held in position by the oxide layer. In other words, the formed oxide layer can prevent unwanted runoff and/or spreading of the molten material produced during the welding process from a weld area. In other words, the formed oxide layer can support the molten material produced during the welding process, thus preventing, in particular, the unwanted runoff of the molten material. For this purpose, the oxide layer can float on the molten material during the welding process. Consequently, the oxide layer can enable the formation of a stable molten droplet during a subsequent welding process, thus preventing, for example, unwanted contact between the coating and the molten material. In particular, due to the supporting function of the oxide layer for the molten material during the welding process, a higher quality of a welded connection produced by the welding process can be achieved. Thus, the method according to an embodiment of the present disclosure advantageously enables better preparation of the elongate conductor element for the welding process.

Preparation can be understood in particular as preparing the elongate conductor element for the welding process.

The elongate conductor element can be described as an electrically conductive element; in particular, the elongate conductor element can be designed as an electrically conductive element.

The elongate conductor element can be suitable for arrangement in an electric machine, for example in the form of an electric motor, forming a stator of the electric machine. A plurality of the elongate conductor elements, when arranged in a stator and electrically connected to one another, can be used for generating a magnetic field which is needed for the operation of the electric machine. The electrical connection of the plurality of the elongate conductor elements to each other can be achieved by means of a welding process.

The elongate conductor element can be designed as a hairpin, in particular the elongate conductor element can be a hairpin. The hairpin can have two elongate legs, in particular parallel to each other, which are connected to each other by means of a connecting portion. One form of the hairpin can be hairpin-shaped. In other words, a hairpin can have a U-shaped form. Alternatively, the elongate conductor element can be designed as a special pin. The special pin can have one, or in particular a single, leg. The elongate conductor element can also be a combination of a hairpin and a special pin.

The elongate conductor element can have a rectangular cross-section. In particular, the core can have a rectangular cross-section. The elongate conductor element can be designed as a rod-shaped conductor with a rectangular conductor cross-section. The edge length of the elongate conductor element can be between 0.2 mm and 15 mm, preferably between 2 mm and 8 mm.

The coating can surround the core in the radial direction, in particular towards the outside. The coating can be an electrical insulation. In particular, the coating can electrically insulate the core from its environment. The coating can have a dielectric strength of 20 to 60 kV/mm. The coating can be a varnish. Preferably the coating can be made of polyamide-imide (abbreviation: PAI), polyetheretherketones (abbreviation: PEEK) or a combination of polyamide-imide and polyimide film (abbreviation: PAI + FEP). The coating can be a single-layer coating or a multi-layer coating. By way of example, the coating can have one layer made of polyamidimide and a further layer made of polyetheretherketone. The coating can be transparent to visible light.

The term “aluminum-containing core” can be understood to mean that the core is made of, or in particular consists of, an aluminum alloy. Preferably, the aluminum-containing core can be made of an aluminum-based alloy with at least 75%, 80%, 90%, 95% or 98% aluminum by weight. The core can be made of, or in particular consist of, aluminum. For example, the aluminum-containing core can be made from the material EN AW-1050A.

The oxide layer can be suitable for stabilizing a molten material produced during the welding process. In particular, the oxide layer can be suitable for preventing the unintentional escape and/or flow of the molten material. The welding process can be a laser welding process. The welding process can involve welding together two elongate conductor elements arranged side by side. In particular, the two elongate conductor elements arranged side by side can be connected to one another in their portions, in which the coating has been removed and the oxide layer has formed.

The oxide layer can be an aluminum oxide layer. The oxide layer can, for example, have a thickness of 5 µm to 25 µm, in particular 10 µm to 20 µm.

The portion can be an end portion. The portion can be arranged at one end of the elongate conductor element.

The laser beam can be a laser beam focused on the portion of the elongate conductor element. The laser beam can be guided by means of a scanner optical unit or a beam guidance element, for example a fiber optic cable.

The laser beam can have a beam quality factor M² of less than or equal to 2, in particular in the range from 1 to 1.4. In an alternative, the laser beam can have a beam quality factor M² of greater than 4. Preferably, the laser beam can have a Gaussian intensity profile. Alternatively, the laser beam can be a multimode laser beam and preferably have a plateau-shaped intensity distribution over its cross-section. A person skilled in the art also refers to this as a top-hat intensity profile. This makes removing the coating and/or heating the electrically conductive core particularly effective.

The laser beam can have a wavelength of 800 nm to 1200 nm, in particular 1030 nm, 1064 nm or 1070 nm. Alternatively, the laser beam can have a wavelength of 500 nm to 550 nm, in particular 515 nm. Alternatively, the laser beam can have a wavelength in a range from 300 nm to 380 nm, preferably 355 nm to 357 nm or 343 nm.

The laser beam can be a continuous-wave laser beam or a pulsed laser beam.

A cross-section of the laser beam can have a symmetrical or an asymmetrical intensity distribution with respect to a center point of the laser beam. The cross-section of the laser beam can be extended in its long extent by a factor of 1.1 to 10 compared to its short extent. For example, the cross-section of the laser beam can exhibit a top-hat-shaped intensity profile in its long extent and a Gaussian intensity profile in its short extent.

The laser beam can be a multi-focal laser beam. A multi-focal laser beam can be understood as having a plurality of, in particular at least two or four, spots at its focus.

Removing the coating and heating the portion can be done simultaneously or sequentially. The coating can be removed mechanically.

Heating by irradiating the portion with the laser beam can be achieved by a single pass or multiple passes of the laser beam over the portion.

Heating by irradiating the portion with the laser beam can be achieved by scanning the portion with the laser beam. Scanning can involve scanning the portion point by point and along parallel, offset lines using a laser beam.

For example, the portion can be irradiated with the laser beam using scanner optical units. In particular, the scanner optical units can be configured to direct the laser beam onto the portion and/or to guide the laser beam across the portion.

The heating can be carried out in such a way that a homogeneous and/or uniform oxide layer is formed. In particular, defects, for example in the form of scratches or inclusions, in an existing oxide layer can be removed by heating.

The heating can be carried out in such a way that an existing oxide layer increases in thickness by at least 10%, preferably 20%.

Heating can be carried out to a temperature of at least 80°C, in particular to a temperature of 80°C to 90°C. This temperature range can be particularly advantageous for the formation of the oxide layer.

In an embodiment of the method, the fluence, in particular the total fluence, of the laser beam is 1 J/cm² to 40 J/cm². In particular, the fluence of the laser beam can be 1 J/cm² to 15 J/cm², 6 J/cm² to 15 J/cm², 6 J/cm² to 8 J/cm². Such fluence of the laser beam can be particularly advantageous for the formation of the oxide layer. In particular, with such fluence of the laser beam, the oxide layer can be formed in such a way that it supports the molten material produced during the welding process.

In an embodiment of the method, the removal of the coating is carried out by irradiating the portion with the laser beam. Advantageously, using the laser beam to remove the coating simplifies the implementation of the method.

In an embodiment of the method, the removal of the coating and the heating of the electrically conductive core are carried out by means of a single pass of the laser beam over the portion. Alternatively, the coating is removed and the electrically conductive core is heated by means of a plurality of, for example two or three, passes of the laser beam over the portion.

For example, a first pass of the laser beam over the portion removes the coating, and a second pass of the laser beam over the portion heats the electrically conductive core. In an alternative example, the coating is removed with a first and a second pass of the laser beam over the portion, and the electrically conductive core is heated with a third pass of the laser beam over the portion.

In an embodiment of the method, the method includes the following step: cleaning the portion of contaminants by irradiating the portion with the laser beam. Cleaning the portion can enable a particularly homogeneous and defect-free formation of the oxide layer. Cleaning the portion and heating the electrically conductive core can be done simultaneously, in particular with a single pass of the laser beam over the portion, or separately in time, in particular with two passes of the laser beam over the portion. Contaminants can include, for example, coating residues, soot, and/or dirt.

For example, in a first step the coating can be irradiated with the laser beam in such a way that it is removed by flaking off. Subsequently, in a second step, the portion can be heated by irradiating it with a laser beam. In particular, the coating of the first step can be flaked off by means of one or two passes of the laser beam over the portion. If the coating is flaked off using two passes, the laser beam can remove the coating in a first pass by locally flaking off the coating in the portion, so that a residual grid of the coating remains after completion of the first pass. In a subsequent second pass of the laser beam over the portion, the laser beam can remove the residual grid of the coating by flaking it off. Additionally, when heating the second step using the laser beam, the portion can simultaneously be cleaned of coating residues by the laser beam.

In an alternative example, the coating can be pre-damaged during the first pass of the laser beam over the portion. The pre-damage can, for example, be carbonization of the coating. Carbonization of the coating can, for example, be the formation of absorption centers in the coating. During a second pass of the laser beam over the portion, the coating can be removed by absorption of the laser beam at the pre-damaged areas. In particular, the coating can be removed during the second pass by burning it off using the laser beam. On a third pass of the laser beam over the portion, the portion can be irradiated in such a way that the portion is heated in order to form the oxide layer. During the third pass, in particular, the portion can be cleaned of smoke at the same time.

In an embodiment of the method, the method includes the following step: removing an existing oxide layer in the portion by irradiating the portion with the laser beam. The formation of the oxide layer is the formation of a new oxide layer. Advantageously, this allows the existing oxide layer, which is inhomogeneous and/or has defects, to be replaced by the new oxide layer, which is homogeneous and/or has no defects. Defects can include, for example, scratches or inclusions in the oxide layer. Additionally, the new oxide layer can be thicker than the previously removed existing oxide layer.

The removal of the existing oxide layer can be done simultaneously with the removal of the coating. Alternatively, the removal of the existing oxide layer can take place before or at the same time as the heating of the electrically conductive core.

The removal of the existing oxide layer and the heating of the electrically conductive core can be carried out with the same or different beam parameters of the laser beam.

In an embodiment of the method, the method includes the following step: flooding the portion with an oxidizing, in particular gaseous, agent. Advantageously, the formation of the oxide layer can be supported by flooding the portion with the oxidizing agent. In particular, the formation of the oxide layer can be controlled by controlling the flooding of the oxidizing agent. For example, the flow rate of the oxidizing agent during the flooding can be changed to control the formation of the oxide layer.

The oxidizing agent can be suitable for supporting the formation of the oxide layer. For example, the oxidizing agent can be oxygen. The flooding of the portion and the heating of the electrically conductive core to form the oxide layer can occur simultaneously or sequentially. In particular, the flooding of the portion can occur after the electrically conductive core has been heated.

In an embodiment of the method, the laser beam exhibits a Gaussian or a top-hat-shaped intensity distribution in its cross-section. The top-hat-shaped intensity distribution can be a homogeneous intensity distribution, which in particular results in a particularly uniform removal of the coating and/or heating of the electrically conductive core across the cross-section of the laser beam.

The top-hat-shaped intensity distribution can have a circular, elliptical, square, or rectangular shape.

In an embodiment of the method, the laser beam is a pulsed laser beam. Advantageously, the pulsed laser beam achieves high peak intensities at moderate average powers, making targeted heat input to the surface of the portion possible. This prevents damage to the coating located outside the portion. A laser pulse of the pulsed laser beam can have a pulse length in the picosecond range or in the nanosecond range, in particular in the range of 1 picosecond to 950 nanoseconds. The pulse repetition rate of the pulsed laser beam can range from 1 kHz to 4 MHz.

In an embodiment of the method, the irradiation of the portion is carried out such that a region irradiated with a laser pulse and a region irradiated with a laser pulse following the laser pulse overlap or do not overlap each other. If the laser pulses overlap, a positive pulse overlap can occur. If the laser pulses do not overlap, a negative pulse overlap can occur. In this context, a second pass can be a successive, multiple irradiation of the same surface portion of the portion, for example in the case of a positive pulse overlap.

A machine tool according to an embodiment of the present disclosure is designed to carry out a method described above.

The machine tool can, in particular, have the following variants for carrying out the method according to the present disclosure:

Variant 1: A laser and an optical unit for beam guidance and use of spot laser radiation;

Variant 2: A laser and an optical unit for beam guidance and use of multi-focal laser radiation;

Variant 3: More than one laser and an optical unit for beam guidance and use of spot laser radiation;

Variant 4: More than one laser and an optical unit for beam guidance and use of multi-focal laser radiation;

Variant 5: More than one laser and more than one optical unit for beam guidance and use of multi-focal laser radiation.

Further advantages and advantageous configurations of embodiments of the present disclosure can be gathered from the figures and the description thereof. All features disclosed herein can be essential both on their own and in any desired combination with one another.

The figures illustrate a method for preparing an elongate conductor element 10 for a welding process. The aim of the method is to form an oxide layer which is suitable to prevent unwanted runoff and/or spreading of the molten material generated during the welding process from a welded area. Advantageously, due to the oxide layer which forms during the welding process, a dimensionally stable molten bead can develop, resulting in a higher quality welded connection produced by the welding process.

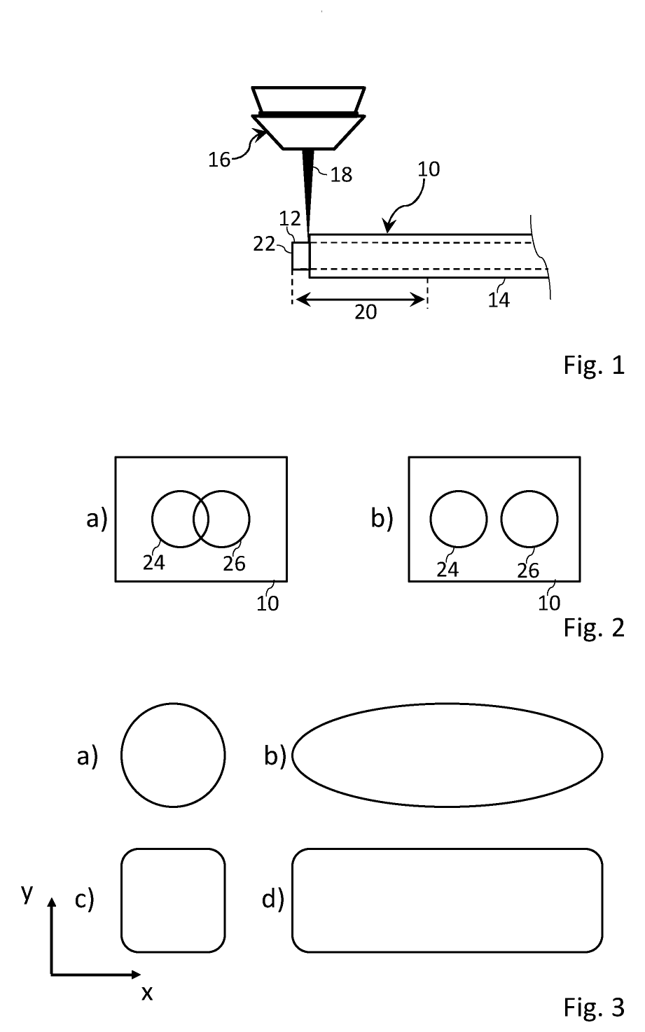

In FIG. 1, the elongate conductor element 10 is shown in the form of an electrically conductive element. The elongate conductor element 10 has an electrically conductive core 12 and a coating 14.

The core 12 is surrounded by the coating 14 in the radial direction outwards. The coating 14 acts as electrical insulation of the core 12 in the radial direction against an environment. The material of the coating 14 is polyamide-imide. The coating has a dielectric strength of 45 kV/mm.

The core 12 has a rectangular cross-section. However, other cross-section shapes can also be provided, such as an octagonal cross-section or a round cross-section. The edge length of the rectangular cross-section can be, for example, 0.2 mm to 15 mm, preferably 2 mm to 8 mm.

The core 12 contains aluminum. In other words, the core 12 is made of an aluminum alloy. In the illustrated exemplary embodiment, the core 12 is made of the material EN AW-1050A.

The elongate conductor element 10 is suitable for arrangement in an electric machine to form a stator of the electric machine. For this purpose, a plurality of identical elongate conductor elements 10, if arranged in a stator configuration, can be electrically connected to each other to form the stator. The electrical connection of the elongate conductor elements 10 is typically achieved by welding the elongate conductor elements 10 together.

The elongate conductor element 10 shown in FIG. 1 is designed as a hairpin.

FIG. 1 shows a machine tool 16 designed to carry out the method for preparing the elongate conductor element 10. The machine tool 16 is configured to generate a laser beam 18 and focus it on a portion 20 of the elongate conductor element 10.

The portion 20 is an end portion of the elongate conductor element 10. In other words, the portion 20 is arranged at one end 22 of the elongate conductor element 10. The length of the portion 20 can be, for example, 0.5 cm to 5 cm, in particular 1 cm to 3 cm. The length of the portion 20 can be measured from the end 22 parallel to a longitudinal axis of the elongate conductor element 10. In the exemplary embodiment shown, the length of the portion 20 is 3 cm.

The coating 14 is removed in the portion 20 by irradiating the portion 20 with the laser beam 18.

In the exemplary embodiment shown in FIG. 1, the machine tool 16 provides the laser beam 18 with a diffraction coefficient M² of 1.3, which has a Gaussian intensity profile in its cross-section. The laser beam 18 has a wavelength of 1030 nm. The laser beam 18 is pulsed. The pulse length of the pulsed laser beam 18 is in the picosecond range and the pulse repetition frequency of the pulsed laser beam 18 is 1 MHz. The laser beam 18 is adjusted in its parameters to the material of the coating 14 such that the laser beam 18 removes the coating 14.

FIG. 1 shows that the coating 14 in the portion 20 is removed by irradiating the portion 20 with the laser beam 18.To this end, the portion 20 is scanned with the laser beam 18. In other words, the portion 20 is scanned point by point by the laser beam 18 along parallel and offset extending lines. The irradiation of the portion 20 can be carried out such that a region 24 irradiated with a laser pulse and a region 26 irradiated with a laser pulse following the laser pulse overlap or do not overlap. For example, FIG. 2a shows that the two irradiated regions 24, 26 overlaps, and FIG. 2b shows that the two irradiated regions 24, 26 do not overlap. This results in a positive pulse overlap in FIG. 2a and a negative pulse overlap in FIG. 2b.

In the exemplary embodiment shown in FIG. 1, the portion 20 is irradiated such that a negative pulse overlap occurs. A fluence, in particular a total fluence, of the laser beam 18 for removing the coating can be, for example, 6 J/cm² to 8 J/cm².In the exemplary embodiment shown in FIG. 1, the fluence of the laser beam 18 is 6.5 J/cm².

This causes the coating to be removed by flaking off in each irradiated region 24, 26. After the laser beam 18 has first passed over the portion 20, a residual grid of the coating 14 remains. This residual grid is removed by a second pass of the laser beam 18 across the portion 20. As a result, the coating 14 is completely removed in the portion 20. In other words, the coating 14 is removed from all sides of the elongate conductor element 10 in the portion 20. Put another way, the coating 14 is removed in the portion 20 all around from all sides of the elongate conductor element 10.

Because FIG. 1 shows the machine tool 16 during the removal of the coating 14, the coating 14 in the region 20 has not yet been completely removed in FIG. 1.

In alternative exemplary embodiments, the coating can be removed with a laser beam that has a top-hat intensity distribution and/or a circular, elliptical, square, or rectangular shape in its cross-section. The different shapes are shown in FIG. 3. FIG. 3a shows the circular shape, FIG. 3b shows the elliptical shape, FIG. 3c shows the square shape, and FIG. 3d shows the rectangular shape. In particular, it can be seen from FIGS. 3c and 3d that the square shape and the rectangular shape have rounded corners. However, this is not mandatory.

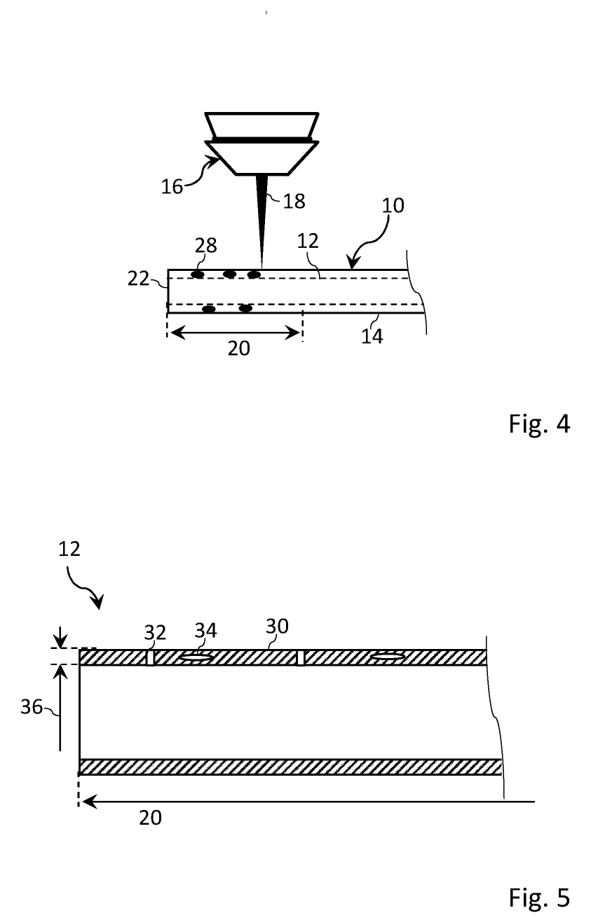

FIG. 4 shows a further exemplary embodiment from FIG. 1, wherein the same reference signs are used for identical and functionally equivalent elements and, in this respect, reference can be made to the explanations given above in relation to the exemplary embodiment of FIG. 1, with the result that essentially only the existing differences are discussed.

In the initial example of FIG. 4, the material of the coating 14 is polyetheretherketone. During the first pass of the laser beam 18 over the portion 20, the coating 14 is pre-damaged. The pre-damage comprises the formation of carbonization sites 28 in the coating. The carbonization sites 28 form absorption centers in the coating where the laser beam is particularly well absorbed during a second pass over the portion 20. Therefore, the removal of the coating occurs during a second pass of the laser beam 18 over the portion 20 by means of absorption of the laser beam 18 at the carbonization points 28. The coating 14 is burned off by the laser beam 18.

After the removal of the coating 14, regardless of whether the coating 14 was removed according to the exemplary embodiment of FIG. 1 or 4, the portion 20 can be cleaned of contaminants by irradiating the portion with the laser beam 18. Contaminants can include, for example, coating residues, soot, and/or dirt. However, cleaning the portion 20 is not mandatory.

FIG. 5 shows a cross-sectional view of the core 12 in the portion 20 after removal of the coating 14. FIG. 5 shows that the surface of the core 12, in particular a lateral surface of the core 12, is formed by an oxide layer 30. The oxide layer 30 is an existing oxide layer 30 made of aluminum oxide. The existing oxide layer 30 has scratches 32 and inclusions 34. The thickness 36 of the existing oxide layer 30 is less than 5 µm. Thus, the existing oxide layer 30 is unsuitable to prevent unwanted runoff and/or spreading of the molten material generated during the welding process from a welded area.

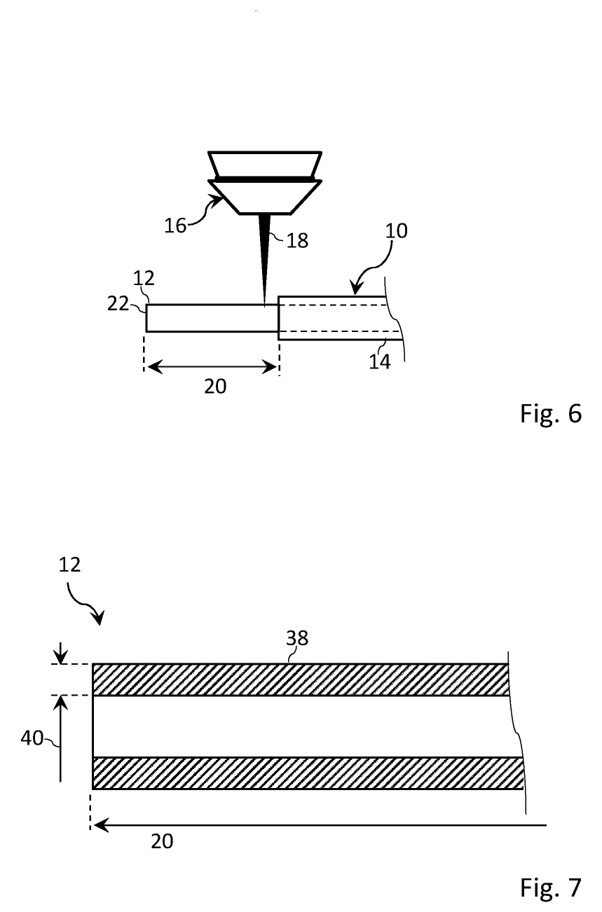

FIG. 6 shows the elongate conductor element 10 of FIG. 1 when heating the electrically conductive core 12 by irradiating the portion 20 with the laser beam 18 in order to form an oxide layer 38 within the portion 20. To this end, an electrically conductive core 12 is scanned with the laser beam 18.

The electrically conductive core 12 is heated to a temperature of at least 80°C, for example 85°C. At such a temperature, the aluminum of the electrically conductive core 12 reacts with oxygen from the environment, forming a homogeneous and/or uniform oxide layer 38.

A fluence, in particular a total fluence, of the laser beam 18 for heating the electrically conductive core 12 can, for example, be 10 J/cm² up to 20 J/cm². In the exemplary embodiment shown in FIG. 6, the fluence of the laser beam 18 is 15 J/cm².

In particular, the pulsed laser beam 18 achieves a targeted heat input on the surface of the portion 20, which prevents damage to the coating 14 located outside the portion 20, for example due to a heated electrically conductive core 12.

By irradiating the portion 20 with the laser beam 18, the existing oxide layer 30 is removed and at the same time the electrically conductive core 12 is heated. As a result of the heating, the oxide layer 38 is formed on the surface of the electrically conductive core 12. The formation of the oxide layer 38 is the formation of a new oxide layer 38. In other words, the existing oxide layer 30, which has scratches 32 and inclusions 34, is replaced by a new oxide layer 38.

FIG. 6 shows a cross-sectional view of the core 12 in the portion 20 after heating the electrically conductive core 12. The new oxide layer 38 has formed on the surface of the electrically conductive core 12. The new oxide layer 38 is an oxide layer made of aluminum oxide. The new oxide layer 38 has no scratches or inclusions. The thickness 40 of the new oxide layer 38 is 20 µm. This means that the new oxide layer 38 is thicker than the previously removed existing oxide layer 30. The new oxide layer 38 is suitable for preventing unwanted runoff and/or spreading of the molten material generated during the welding process from a welding area.

In an alternative exemplary embodiment, the method includes the step: flooding the portion with an oxidizing, in particular, gaseous, agent in the form of oxygen. The flooding can occur simultaneously with the irradiation of the portion with the laser beam.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for preparing an elongate conductor element for a welding process, wherein the elongate conductor element has an electrically conductive core and a coating, and the core contains aluminum, the method comprising:
removing the coating within a portion of the elongate conductor element; and
heating the electrically conductive core by irradiating the portion of the elongate conductor element with a laser beam to form an oxide layer within the portion of the elongate conductor element.

2. The method according to claim 1,
wherein a fluence of the laser beam is 1 J/cm² to 40 J/cm².

3. The method according to claim 1,
wherein the removing of the coating is carried out by irradiating the portion of the elongate conductor element with the laser beam.

4. The method according to claim 1,
wherein the removing of the coating and the heating of the electrically conductive core are carried out by a single pass with the laser beam over the portion of the elongate conductor element.

5. The method according to claim 1, comprising cleaning the portion of the elongate conductor element of contaminants by irradiating the portion of the elongate conductor element with the laser beam.

6. The method according to claim 1, comprising removing an existing oxide layer within the portion of the elongate conductor element by irradiating the portion of the elongate conductor element with the laser beam,
wherein forming the oxide layer includes forming a new oxide layer.

7. The method according to claim 1, comprising flooding the portion of the elongate conductor element with an oxidizing gaseous agent.

8. The method according to claim 1,
wherein the laser beam has a Gaussian or a top-hat-shaped intensity distribution in its cross-section.

9. The method according to claim 1,
wherein the laser beam is a pulsed laser beam.

10. The method according to claim 9,
wherein irradiating the portion of the elongate conductor element is carried out such that a region irradiated with a laser pulse and a region irradiated with a further laser pulse following the laser pulse overlap or do not overlap each other.

11. A machine tool configured to carry out the method according to claim 1.

12. The method according to claim 1, wherein the removing of the coating and the heating of the electrically conductive core are carried out by a plurality of passes with the laser beam over the portion of the elongate conductor element.
